(19) United States
(12) Patent Application Publication
(10) Pub. No.: US 2025/0162348 A1
(43) Pub. Date: May 22, 2025

(54) WHEEL ASSEMBLY FOR A LUGGAGE BAG

(71) Applicant: Sharon Thompson, Fort Lauderdale, FL (US)

(72) Inventor: Sharon Thompson, Fort Lauderdale, FL (US)

(21) Appl. No.: 18/610,626

(22) Filed: Mar. 20, 2024

Related U.S. Application Data
(60) Provisional application No. 63/599,701, filed on Nov. 16, 2023.

(51) Int. Cl. B60B 33/00; A45C 5/14

(52) U.S. Cl. CPC B60B 33/0005; A45C 5/143; B60B 33/0018; B60B 33/0049; B60B 2200/45

(57) ABSTRACT

The present invention provides a wheel assembly for a luggage bag. The wheel assembly comprises a mounting plate, a fork, at least one wheel and at least one magnet. The mounting plate is adapted to be configured on a peripheral portion of the luggage bag. The fork extends from the mounting plate and at least one wheel is connected to the fork. The magnet is adapted to be arranged on an inner portion of the luggage bag opposite to the corresponding mounting plate. When the luggage bag is brought into proximity with the mounting plate, the magnet inside the luggage bag is attracted to the mounting plate and securely connects with the mounting plate, thereby fastening the wheel assembly to the luggage bag.

### FIELD OF THE INVENTION

This application claims the benefit of U.S. Provisional Application No. 63/599,701 filed on Nov. 16, 2023. The present invention relates to a wheel assembly, particularly, to a detachable wheel assembly for a luggage bag.

### BACKGROUND OF THE INVENTION

Wheel assemblies on luggage bags, commonly known as “spinner wheels” or “rolling wheels,” have revolutionized the way people travel by making it much easier to maneuver heavy luggage through various environments such as airports, train stations, and city streets.

Traditional luggage used to have only two fixed wheels, requiring travelers to tilt the bag and pull or push it along. This design was less convenient and put more strain on the traveler's wrists and arms.

Spinner wheels were introduced to provide a more effortless and flexible way of moving luggage. Spinner wheels are small, multidirectional wheels that can rotate 360 degrees. They are usually attached to the bottom corners of the luggage bag. The design allows the bag to be pushed, pulled, or glided alongside the traveler without having to tilt it.

Spinner wheels come in various sizes and designs, with some bags featuring four spinner wheels for optimal stability and maneuverability. Travelers can effortlessly glide their luggage in any direction without straining their wrists or arms and thus experiencing less physical strain when navigating crowded areas or long distances.

Further, four-wheel spinner bags provide better stability when standing upright, reducing the risk of tipping over. These spinner wheels work well on various surfaces, including smooth floors, carpets, and uneven terrain.

Some luggage brands offer detachable wheel assemblies in different sizes and styles. This allows the user to customize their luggage to better suit their preferences and needs.

Detachable wheel assemblies on luggage bags offer several advantages that can enhance the convenience, versatility, and longevity of luggage. For example, detachable wheel assemblies make it simpler to replace or repair damaged wheels. If a wheel becomes worn out or broken, the user can often purchase a replacement wheel assembly and easily attach it to the luggage.

Detachable wheel assemblies can also provide more efficient storage, especially when they are not in use. By removing the wheels, the luggage can lie flat or be stored in tighter spaces, such as under a bed or in a closet. This is particularly useful if one has limited storage space at home.

However, detachable wheel assemblies in the prior art have many potential disadvantages to consider. For example, current detachable wheel assemblies can introduce an added level of complexity to luggage design. The mechanisms and attachments used to secure the wheels require more maintenance and attention, and there is a potential for parts to break or malfunction.

The points at which the wheel assemblies attach to the luggage can also be vulnerable to wear and tear over time, especially if the attachment mechanism is not robust. If the attachments become loose or damaged, it can affect the stability and functionality of the wheels.

The attachment mechanisms and components of current detachable wheel assemblies may also require regular maintenance to ensure proper functionality, such as tightening screws, checking for wear, and cleaning the attachment points to prevent dirt or debris buildup, which can be time consuming.

Further, with these current detachable wheel assemblies, the user needs to attach the wheels before using the luggage and detach them when they want to store or carry the bag without wheels. While these steps might not be overly complicated, they do add extra time and effort to the travel preparations and allow the possibility of error in installing the wheels, especially if the user is rushed for time. If the wheels are not properly attached, it could lead to stability issues during travel.

Therefore, there is a need for a wheel assembly that can overcome the deficiencies of the existing detachable wheel assemblies on luggage bags.

### SUMMARY OF THE INVENTION

In a first implementation of the invention, a wheel assembly may comprise a mounting plate, a fork, at least one wheel and at least one magnet. The wheel assembly solves the aforementioned deficiencies present in the prior art by enabling easy attachment and detachment of the wheel assembly, via the at least one magnet.

The mounting plate may be adapted to be configured on a peripheral portion of the luggage bag. Particularly, the mounting plate may be a substantially flat frame adapted to be configured on a bottom portion of the luggage bag. The mounting plate may include an attachment point where the fork and the at least one wheel can be connected.

The fork may extend from a portion of the mounting plate. Particularly, the fork may include two arms that extend outward from the mounting plate. The arms securely hold and support the at least one wheel on either side.

The at least one wheel may be connected to the fork and may include a central hub and an outer rim. The central hub may provide a mounting point for attaching the at least one wheel to the fork, while the outer rim makes contact with the ground during movement.

In an aspect, the at least one wheel may be connected to the fork by a push-on mechanism. In another aspect, the at least one wheel may be attached to the fork using a locking nut, or other similar fastening methods, to ensure a secure connection.

In an aspect, the at least one magnet may be adapted to be arranged on an inner portion of the luggage bag, opposite to the corresponding mounting plate. The at least one magnet may be positioned within the interior of the luggage bag, particularly near the bottom or sides of the luggage bag. In an aspect of the invention, the at least one magnet may be a Neodymium magnet.

The at least one magnet is aligned with the mounting plate such that the magnetic force between the at least one magnet and the mounting plate securely hold the wheel assembly on the bottom portion of the luggage bag. In an aspect, two magnets may be arranged inside the bottom portion of the luggage bag corresponding to two mounting plates arranged beneath the luggage bag.

When the luggage bag is brought into proximity with the mounting plate, the at least one magnet inside the luggage bag is attracted to the mounting plate and securely connects with the mounting plate, thereby fastening the wheel assembly to the luggage bag.

In another aspect, the wheel assembly may include two or more mounting plates adapted to be arranged on the peripheral portion of the luggage bag and corresponding magnets may be arranged inside the luggage bag.

In another aspect, the at least one magnet may be positioned near the bottom or sides of the luggage bag and the at least one magnet is aligned with the mounting plate such that the magnetic force between the at least one magnet and the mounting plate securely hold the wheel assembly on the bottom portion of the luggage bag.

In another aspect, the mounting plate may include magnet-receptive areas, such as magnetic strips, zones, grooves, slots, receptacles, or indentations that correspond to the at least one magnet's placement and help to align with the position of the magnet inside the luggage bag.

In another aspect, the luggage bag may include cavities or slots to dispose the magnets therewithin opposite to the corresponding mounting plate positioned beneath the luggage bag.

In another aspect, the fork may be extendable between the at least one wheel and the mounting plate. The fork may be a telescopic fork consisting of two or more nested tubes, allowing one tube to slide within another to extend and retract, providing adjustable height options.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a side perspective view of a wheel assembly for a luggage bag in accordance with the present invention.

FIG. 2 presents a front perspective view of an arrangement of a magnet inside a bottom portion of the luggage bag in accordance with the present invention;

FIG. 3 presents a detailed view of an arrangement of the wheel assembly on the luggage bag in accordance with the present invention;

FIG. 4 presents an assembled view of the wheel assembly on the luggage bag in accordance with the present invention;

FIG. 5 presents a detailed assembled view of the wheel assembly on the luggage bag in accordance with the present invention;

FIG. 6 presents a side view of the luggage bag with wheel assembly in accordance with the present invention; and

FIG. 7 presents an implementation of the wheel assembly being placed into another luggage bag in accordance with the present invention.

Like reference numerals refer to like parts throughout the several views of the drawings.

### DETAILED DESCRIPTION

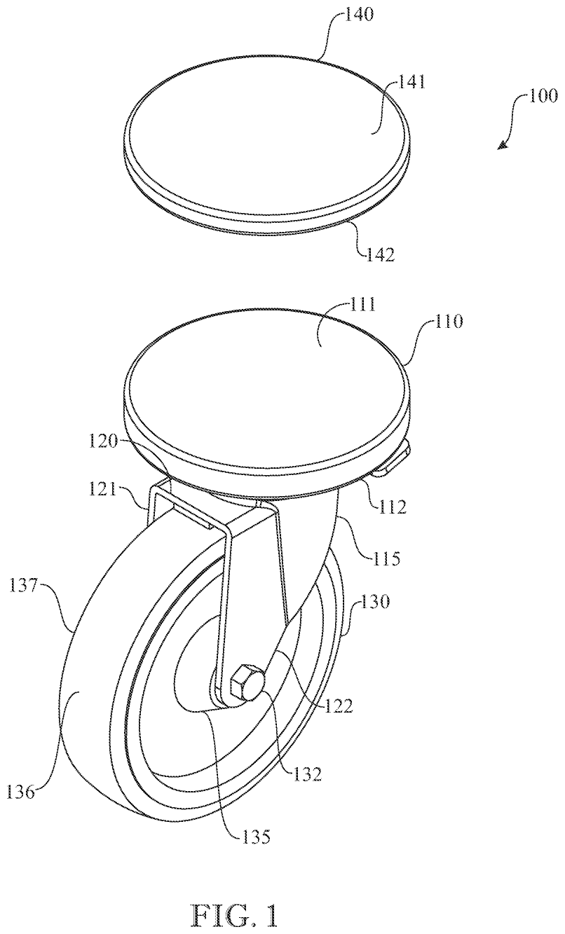

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. The term “comprising” can also encompass the terms “consisting essentially of” and “consisting of”.

Shown throughout the figures, the present invention is directed toward a wheel assembly for a luggage bag. Specifically, the present invention is directed towards a detachable wheel assembly that can be arranged on a luggage bag, a suitcase, or any other similar carrying cases.

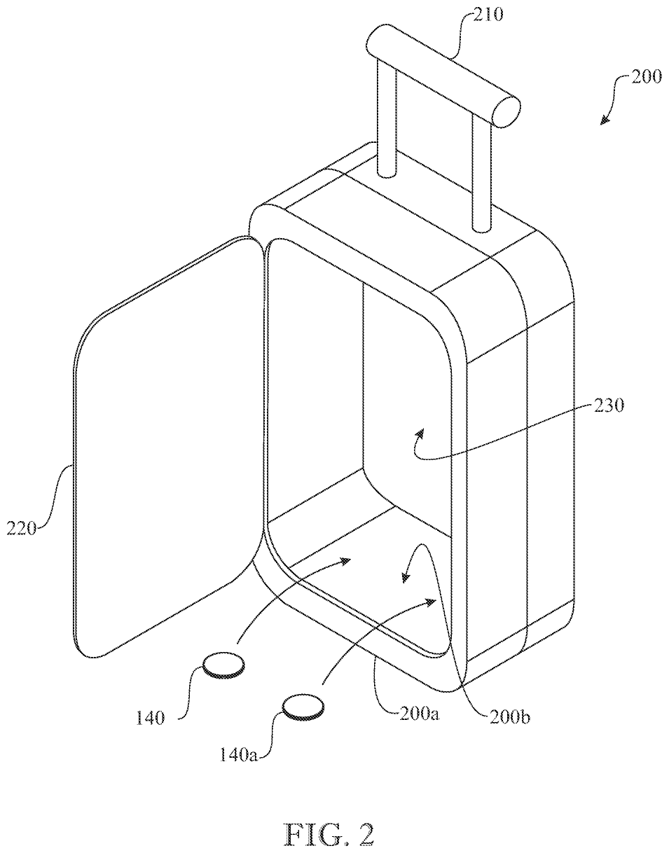

Referring initially to FIGS. 1-2, a wheel assembly 100 for a luggage bag 200 in accordance with the present invention is illustrated. The wheel assembly 100 is adapted to be arranged on a portion of the luggage bag 200; particularly, the wheel assembly 100 may be adapted to be arranged on a bottom peripheral portion 200a such that the user can move the luggage bag 200. It should be appreciated that the luggage bag 200 refers to a bag, a suitcase, or any type of portable container used for carrying personal belongings, clothing, accessories, and other articles during travel. In the present embodiment, the wheel assembly 100 is a detachable wheel assembly 100 that can be removed and securely disposed within the luggage bag 200 according to user requirement. The luggage bag 200 may include a handle 210 and a lid 220 for opening and closing a storage area 230 of the luggage bag 200.

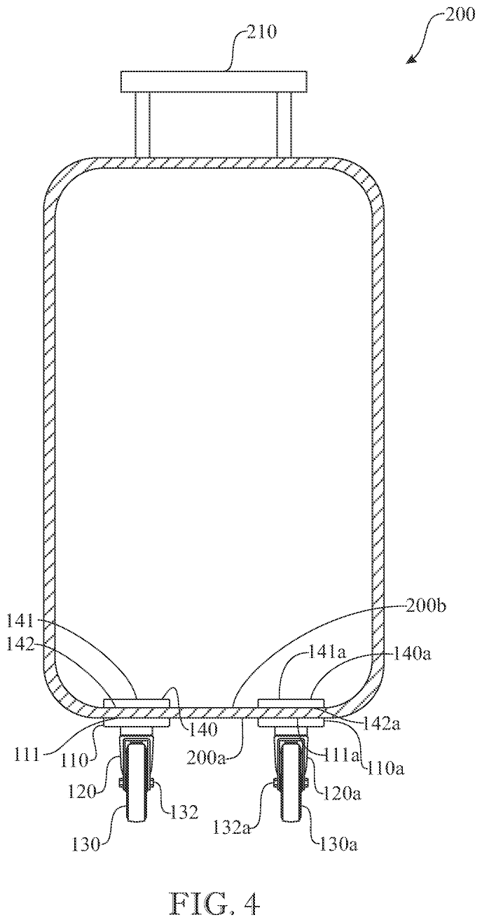

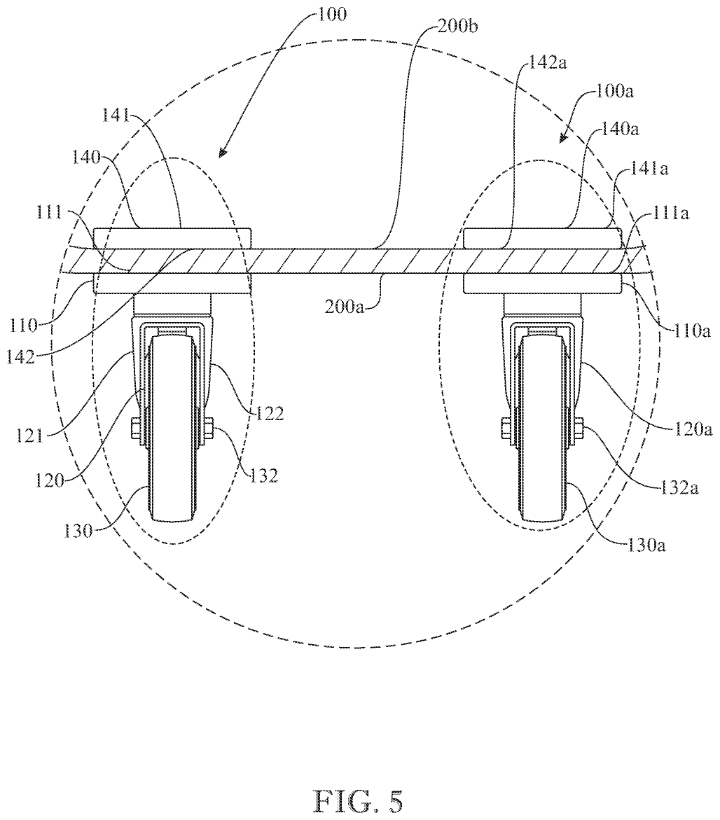

Referring again to FIG. 1, the wheel assembly 100 may include a mounting plate 110, a fork 120, at least one wheel 130 and a magnet 140. The mounting plate 110 may be a substantially flat frame adapted to be arranged on a peripheral portion of the luggage bag 200 (as shown in FIGS. 4-5). Specifically, an upper portion 111 of the mounting plate 110 is connected to the peripheral portion of the luggage bag 200. It may be obvious to a person skilled in the art to configure the mounting plate 110 on a portion of the luggage bag 200 likely to be touching the ground. The portion can be a bottom peripheral portion 200a or any of the side portion or a top portion of the luggage bag 200. The mounting plate 110 may further include attachment points 115 where the fork 120 and the at least one wheel 130 are connected. These attachment points 115 may be reinforced areas that distribute the load evenly across the mounting plate 110. The attachment points 115 are positioned to maintain the stability of the wheel assembly 100 while allowing the fork 120 and the at least one wheel 130 to pivot smoothly during movement.

Referring again to FIG. 1, the fork 120 may extend from a lower portion 112 of the mounting plate 110. Specifically, the fork 120 may include two fork arms 121, 122 that extend outward from the mounting plate 110. The fork arms 121, 122 may securely hold and support the at least one wheel 130 on either side. Each of the fork arms 121, 122 may include provisions for attaching the at least one wheel 130. For example, the present embodiment may include axles/axle bolts 132 that fit through the center of the at least one wheel 130, where the at least one wheel 130 is securely fixed. Within the fork arms 121, 122, there may be spaces or recesses for installing wheel bearings (not shown). Wheel bearings enable smooth rotation of the at least one wheel 130 and reduce friction, ensuring effortless movement. These bearings can be sealed to protect against dust and debris.

Further, the fork 120 may be seamlessly integrated with the mounting plate 110, with its attachment points aligning with the mounting plate's 110 connection points. The fork 120 has appropriate clearance between the wheels 130 and the luggage bag's 200 body to prevent interference during movement. The fork 120 also ensures that the at least one wheel 130 makes solid ground contact to facilitate smooth rolling.

With continued reference to FIG. 1, the at least one wheel 130 is illustrated being connected to the fork 120 by axles/axle bolts 132, as discussed above. The at least one wheel 130 may include a central hub 135 and an outer rim 136. The central hub 135 provides a mounting point for attaching the at least one wheel 130 to the fork 120, while the outer rim 136 makes contact with the ground during movement. The at least one wheel 130 may be made from durable and resilient materials such as rubber, polyurethane, or a combination of materials. These materials offer shock absorption, wear resistance, and traction on different surfaces. In an embodiment, an outer surface 137 of the outer rim 136 may feature a tread pattern (not shown) to optimize traction and rolling performance. The tread pattern can vary depending on the intended use of the luggage bag 200. For example, the at least one wheel 130 may have grooves or patterns that enhance grip on smooth surfaces.

Further, the central hub 135 of the at least one wheel 130 may be designed to fit securely onto the fork's axle 132 or attachment point. The central hub 135 may include a central bore that fits over the axle/axle bolt 132 or a locking mechanism (not shown) to prevent the at least one wheel 130 from coming loose during usage. Further, the central hub 135 may contain bearings (not shown) that enable the wheel 130 to rotate smoothly around its axle 132. The bearings can be ball bearings or roller bearings, providing low friction and facilitating effortless movement. It may be obvious to a person skilled in the art to configure the wheel's 130 diameter and width based on the luggage bag's size and intended use. In an embodiment, the at least one wheel 130 may be connected to the fork 120 by a push-on mechanism (not shown). In another embodiment, the at least one wheel 130 may be attached to the fork 120 using a locking nut (not shown), or other similar fastening methods to ensure a secure connection.

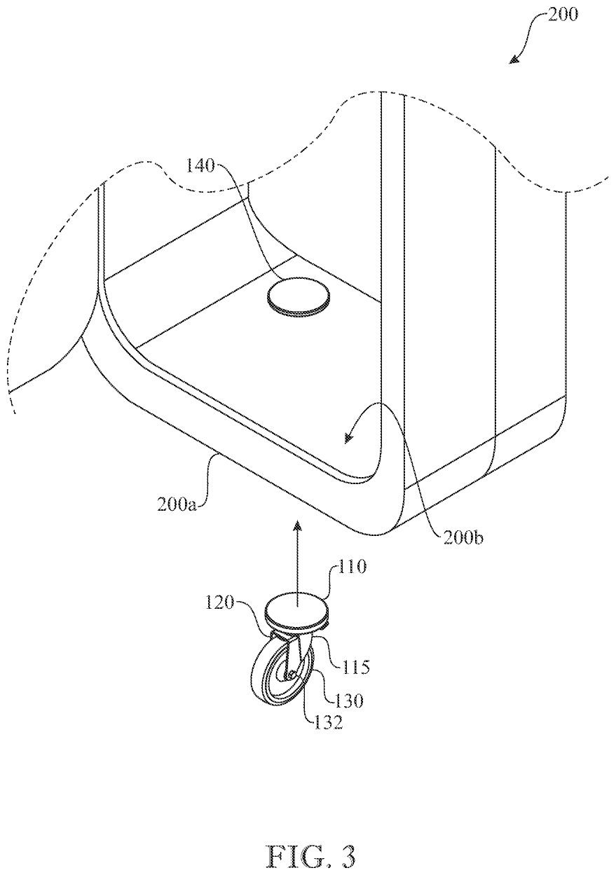

Referring now to FIGS. 2-3, the magnet 140, is shown positioned within the interior of the luggage bag 200, particularly near the bottom or sides of the luggage bag 200. In the present embodiment, the magnet 140 may be a Neodymium magnet. In another embodiment, the magnet 140 may be an electromagnet. It may be obvious to a person skilled in the art to use any other similar magnets with powerful magnetic properties. The magnet 140 is aligned with the mounting plate 110 such that a magnetic force between the magnet 140 and the mounting plate 110 securely hold the wheel assembly 100 on the bottom portion 200b of the luggage bag 200.

In one exemplary embodiment, a single wheel assembly 100 may be arranged on a bottom portion of the luggage bag 200. When the luggage bag 200 is brought into proximity with the mounting plate 110, the magnet 140 inside the luggage bag 200 is attracted to the mounting plate 110. This magnetic attraction creates a secure connection between the mounting plate 110 and the magnet 140, thereby fastening the wheel assembly 100 to the luggage bag 200.

In the embodiment shown in FIGS. 4-5, two-wheel assemblies 100, 100a may be arranged on a bottom peripheral portion 200a of the luggage bag 200. In an aspect of the invention, a luggage bag 200 may comprise a first wheel assembly 100 and a second wheel assembly 100b. The first wheel assembly 100 may comprise a fork 120 extending from the mounting plate 110, a wheel 130 connected to the fork 120, and a magnet 140 adapted to be arranged on an inner bottom portion 200b of the luggage bag 200 opposite to the corresponding mounting plate 110. The second wheel assembly 100a may comprise a fork 120a extending from the mounting plate 110a, a wheel 130a connected to the fork 120a and a magnet 140a adapted to be arranged on an inner bottom portion 200b of the luggage bag 200 opposite to the corresponding mounting plate 110. When the luggage bag 200 is brought into proximity with the mounting plate 110, 100a, the magnet 140, 140a inside the luggage bag 200 is attracted to the mounting plate 110, 110a and securely connects with the corresponding mounting plates 110, 100a thereby fastening the wheel assembly 100 to the luggage bag 200. The magnet 140, 140a may be positioned near the bottom or sides of the luggage bag 200 and aligned with the mounting plate 110, 110a such that the magnetic force between the magnet 140, 140a and the mounting plate 110, 110a securely hold the wheel assembly 100, 100a on the bottom portion 200a of the luggage bag 200.

In the present embodiment demonstrated in FIGS. 3-5, two magnets 140, 140a may be arranged inside a bottom portion 200b of the luggage bag 200 corresponding to two mounting plates 110, 110a arranged beneath the luggage bag 200. Specifically, a lower portion 142, 142a of the magnets 140, 140a faces towards the corresponding upper portion 111, 111a of the mounting plates 110, 110a. The upper portion 141, 141a of the magnet 140, 140a faces towards the articles kept within the luggage bag 200. Again, this magnetic attraction creates a secure connection between the mounting plate 110, 110a and the magnets 140, 140a, thereby fastening the wheel assembly 100, 100a to the luggage bag 200.

In an embodiment, the mounting plates 110, 110a may include magnet-receptive areas, such as magnetic strips, zones, grooves, slots, receptacles, or indentations that correspond to the magnet's placement and help to align with the position of the magnet 140, 140a inside the luggage bag 200. This enables a seamless magnetic connection between the luggage bag 200 and the wheel assembly 100, 100a, enhancing the stability and secure attachment between the mounting plate 110, 110a and the magnets 140, 140a within the luggage bag 200. Such arrangement ensures a snug fit when the luggage bag 200 with magnet 140, 140a is brought near the mounting plate 110, 110a. In another embodiment, the luggage bag 200 may have cavities or slots to dispose the magnets 140, 140a therewithin opposite to the corresponding mounting plates 110, 110a positioned beneath the luggage bag 200.

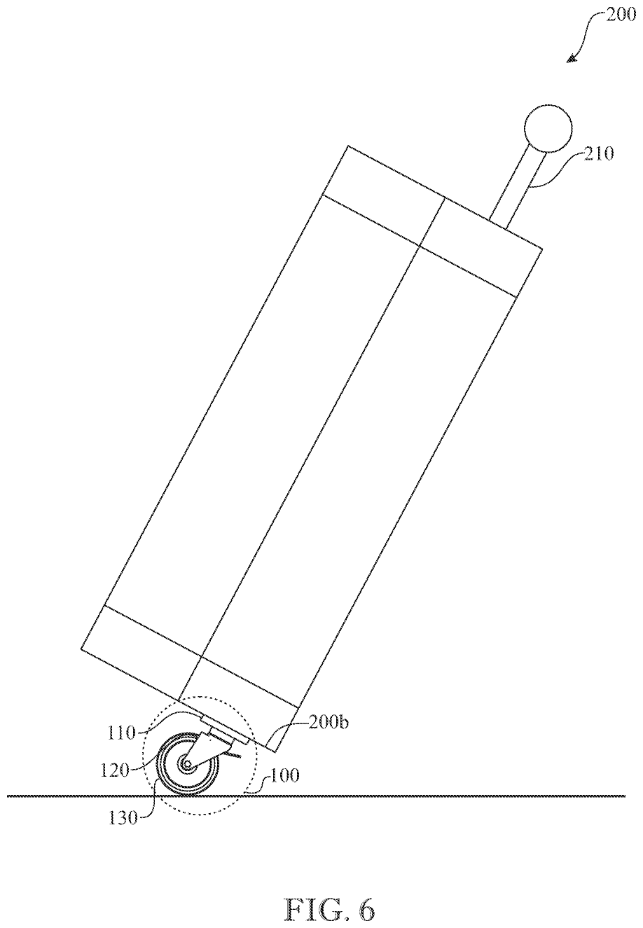

Referring now to FIG. 6, there is illustrated the wheel assembly 100 mounted to the luggage bag 200, and more particularly, the bottom peripheral portion 200a of the luggage bag 200 and is shown being used to transport the luggage bag 200. As shown and discussed above, the wheel assembly 100 may include the mounting plate 110, the fork 120 and the at least one wheel 130.

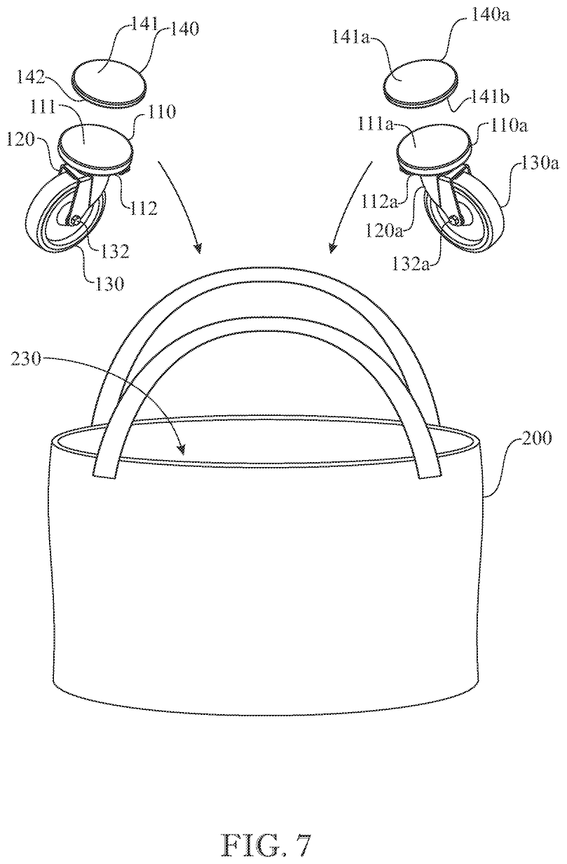

Referring now to FIG. 7, there is illustrated a luggage bag 200 according to another embodiment of the present disclosure, wherein the luggage bag 200 is a carrying bag. Here, the wheel assemblies 100, 100a are shown detached from the luggage bag 200 and being placed into a storage area 230 (e.g., the interior of the luggage bag 200) for transportation of the wheel assemblies 100, 100a when not needed for use in transporting the luggage bag 200.

Alternative embodiments are contemplated in addition the embodiments shown and/or described herein. For example, in an embodiment, the fork 120, 120a may be extendable between the wheels 130, 130a and the mounting plates 110, 110a. In this embodiment, the fork 120, 120a may be a telescopic fork (not shown) that consists of two or more nested tubes, allowing one tube to slide within another. This telescoping mechanism enables the fork 120a, 120b to extend and retract, providing adjustable height options. The telescopic mechanism of the fork 120, 120a may be useful for when the handle 210 FIG. 2 of the luggage bag 200 is short or not sufficiently long enough to hold the luggage bag 200.

The telescoping forks can be collapsed, making the wheel assembly 100, 100a more compact for storage. In an embodiment, the telescopic forks may include a locking mechanism (not shown) that keeps the tubes securely extended. This prevents unintentional collapsing of the wheel assembly 100, 100a while in use. In another embodiment (not shown), the wheel 130, 130a may include a dual wheel design. In such embodiment, the fork 120, 120a may be arranged between two wheels of the wheel assembly 100, 100a. This arrangement involves using two wheels mounted on a single fork (not shown).

In such embodiment (again, not shown), the fork 120, 120a may include a central base that connects to the mounting plate 110 of the wheel assembly 100. Two arms may extend from the central base in opposite directions, creating a “Y” shape. The wheels 130, 130a may be positioned on the ends of the two arms of the fork 120, 120a. Each wheel 130, 130a may be attached to an axle that extends through the wheel's central hub. In such embodiment, the fork 120, 120a may include a swivel mechanism that allows the wheel 130, 130a to rotate 360 degrees.

In an embodiment (not shown), the wheel assembly 100 may include two or more mounting plates 110, 110a adapted to be arranged on the peripheral portion of the luggage bag 200 and corresponding magnets are arranged inside the luggage bag 200.

In another embodiment (not shown), the fork 120, 120a may include braces, ribs, or crossbars between the arms to strengthen the overall structure of the wheel assembly 100 and to prevent wobbling during the use. In an embodiment, the fork 120 may be made of metals like steel or aluminum, or any engineering plastics.

In another embodiment (not shown), the mounting plate 110, 110a may include reinforcement elements such as ribs, braces, or flanges. The reinforcement elements may enhance the overall strength and load-bearing capacity of the wheel assembly 100, 100a, allowing the wheel assembly 100, 100a to support the weight of the luggage bag 200 and its containing articles.

In another embodiment (not shown), the mounting plate 110, 110a may include fastening points for securing the mounting plate 110, 110a to the luggage bag 200. The fastening points may include holes, slots, or other features to accommodate screws, bolts, or other fasteners, ensuring a secure connection between the mounting plate 110, 110a and the luggage bag 200.

The present invention has an advantage of providing a wheel assembly 100 for a luggage bag 200 which significantly enhances the mobility of the luggage bag 200. The wheels enable smooth and effortless movement across various surfaces, reducing the physical effort required by the user. The integration of the mounting plate 110 and magnet mechanism ensures a secure attachment of the wheel assembly 100 to the luggage bag 200 eliminating the need for complex installation procedures and providing users with a convenient and reliable solution.

The magnetic connection between the mounting plate 110 and the magnet 140 streamlines the installation process. Users can swiftly attach or detach the wheel assembly 100 without the necessity of additional tools or hardware. Further, the design of the wheel assembly 100 minimizes the space occupied within the luggage bag 200, allowing users to maximize the available storage area for their belongings. The magnetic attachment system is adaptable to various luggage bag 200 designs and sizes. This versatility ensures that the wheel assembly 100 can be integrated into a wide range of luggage products.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A wheel assembly removably attachable to an object, comprising:
a mounting plate;
a lower portion member extending from a lower surface of the mounting plate, the lower portion member including a pair of parallel extending arms spaced apart creating a gap;
at least one wheel attached to the parallel extending arms and disposed within the gap and free to rotate; and
at least one magnet that is magnetically attracted to the mounting plate.

2. The wheel assembly of claim 1, wherein the mounting plate is adapted to be disposed in fluid communication with an exterior portion of an object and the magnet is adapted to be configured to be disposed in fluid communication with an interior portion of the object.

3. The wheel assembly of claim 1, wherein the wheel assembly is secured to an object by disposing the magnet to an interior surface of the object and disposing the mounting plate directly opposite the magnet on an exterior surface of the object, and wherein the magnetic forces between the magnet and the mounting plate hold the wheel assembly to the object.

4. The wheel assembly of claim 1, wherein the wheel includes a central hub and an outer rim, the central hub providing a mounting point for attaching the at least one wheel to the arms of the lower portion member.

5. The wheel assembly of claim 1, wherein the wheel is attached to the lower portion member using a push-on mechanism.

6. The wheel assembly of claim 1, wherein the wheel is attached to the lower portion member using a fastener.

7. The wheel assembly of claim 1, wherein the magnet comprises a neodymium magnet.

8. The wheel assembly of claim 1, wherein the mounting plate includes an upper surface that includes elements embossed or protruding from the upper surface of the mounting plate that correspond with elements on the magnet to help alignment of the magnet's positioning to the mounting plate.

9. The wheel assembly of claim 1, wherein the arms of the lower portion member are adjustable arms.

10. The wheel assembly of claim 1, wherein the mounting plate includes a substantially flat upper surface.

11. A wheel assembly removably attachable to a luggage article, comprising:
a mounting plate;
a forked arms extending from a lower surface of the mounting plate that provide a gap;
at least one wheel attached to the forked arms and disposed within the gap and free to rotate; and
at least one magnet that is magnetically attracted to the mounting plate,
wherein the magnet is disposable within an interior portion of the luggage article and the mounting plate is disposable on an outer portion of the luggage article, and the magnetic forces between the mounting plate and the magnet securely holds the wheel assembly to the luggage article.

12. The wheel assembly of claim 11, wherein the wheel includes a central hub and an outer rim, the central hub providing a mounting point for attaching the at least one wheel to the arms of the lower portion member.

13. The wheel assembly of claim 1, wherein the wheel is attached to the lower portion member using a push-on mechanism.

14. The wheel assembly of claim 11, wherein the wheel is attached to the lower portion member using a fastener.

15. The wheel assembly of claim 11, wherein the magnet comprises a neodymium magnet.

16. A method for attaching a wheel assembly to a luggage article, comprising the steps of:
providing a wheel assembly, comprising,
a mounting plate;
a lower portion member extending from a lower surface of the mounting plate, the lower portion member including a pair of parallel extending arms spaced apart creating a gap;
at least one wheel attached to the parallel extending arms and disposed within the gap and free to rotate, and
at least one magnet that is magnetically attracted to a surface of the mounting plate; and
placing the magnet within an interior space of the luggage article and aligning the mounting plate on an outer surface of the luggage article to the magnet such that the magnetic forces between the mounting plate and the magnet securely holds the wheel assembly to the luggage article.

17. The wheel assembly of claim 1, wherein the magnet comprises a neodymium magnet.

18. The wheel assembly of claim 11, wherein the wheel includes a central hub and an outer rim, the central hub providing a mounting point for attaching the at least one wheel to the arms of the lower portion member.

19. The wheel assembly of claim 1, wherein the wheel is attached to the lower portion member using a push-on mechanism.

20. The wheel assembly of claim 11, wherein the wheel is attached to the lower portion member using a fastener.
